(19) United States
(12) Patent Application Publication
(10) Pub. No.: US 2026/0064885 A1
(43) Pub. Date: Mar. 5, 2026

(54) DATA FABRICATION

(71) Applicant: Wells Fargo Bank, N.A., San Francisco, CA (US)

(72) Inventors: Prasad V. Pondicherry, Plano, TX (US); Ravinderjit Singh, Woodstock, MD (US)

(21) Appl. No.: 18/819,592

(22) Filed: Aug. 29, 2024

(51) Int. Cl. G06F 21/62

(52) U.S. Cl. CPC G06F 21/6254

(57) ABSTRACT

An example computer system and method for masking personally identifiable information in a non-production environment is presented. The computer system includes one or more processors and non-transitory computer-readable storage media. The encoded instructions, when executed by the one or more processors, cause the computer system to: identify columns within a database application that contain PII; register these columns in a configuration table; generate database view definitions that include instructions to replace the PII within the columns with either null values or anonymized data, thus creating compliant views; and generate these compliant views within the production environment. The method also involves extracting test data from the compliant views and loading this data into a user acceptance testing object, facilitating secure testing and development while adhering to data protection standards.

### BACKGROUND

In the domain of data management within non-production environments, the prevalent practice involves duplicating production data, inclusive of real user information, for use in development, testing, and staging environments. This may necessitate the direct transfer of sensitive data into lower environments, posing significant risks to data privacy and often failing to adhere to rigorous data protection regulations.

Current methods employed for data masking in such environments typically require extensive preparation and configuration to effectively mask sensitive data. These methods are characterized by their substantial storage demands, as they retain both the original data extracts prior to masking and the processed data post-masking. Additionally, these methods generally operate by processing data masking in a sequential snapshot manner, which is notably inefficient and time-consuming, especially when handling large datasets or needing frequent updates. This inefficiency not only burdens resources but also prolongs development cycles, thereby reducing operational efficacy.

### SUMMARY

Embodiments of the disclosure are directed to masking personally identifiable information data in non-production environments utilizing database views that do not store data but present the data from underlying tables in a modified form. This concept comprises identifying columns within a database application that contain personally identifiable information data, registering these columns in a configuration table tailored for data masking management, and generating database view definitions based on this configuration. The views are structured to replace personally identifiable information data within the columns with null values or anonymized data, thereby creating compliant views.

Further, the concept includes deploying the compliant views within a governed, secured, and segregated lane of production environment, ensuring that any access to the data through these views does not expose the personally identifiable information data. The system facilitates the extraction of test data from these views, which is then loaded into user acceptance testing objects. This approach eliminates the need for storing duplicated, sensitive data in non-production environments, enhancing data privacy and reducing storage requirements. This concept also allows for dynamic updating of view definitions in response to changes in data structure or privacy requirements, maintaining compliance with data protection regulations and improving operational efficiency in software testing and development processes.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for masking personally identifiable information data.

FIG. 2 shows components of a server device of the system of FIG. 1.

FIG. 3 shows components of a data masking repository of the system of FIG. 1.

FIG. 4 illustrates an example embodiment of the server and database of FIG. 1 implementing the generation of compliant views for data masking.

FIG. 5 illustrates an example method for masking data and managing compliance using the system of FIG. 1.

FIG. 6 shows example physical components of the server device of FIG. 2.

### DETAILED DESCRIPTION

This disclosure relates to masking personally identifiable information (PII) in non-production environments to enhance data security and compliance with privacy regulations. The concept involves the use of database views that do not store data but dynamically present modified data from the underlying database tables, effectively masking sensitive information.

Traditional methods of preparing test data in non-production environments often involve direct copying of production data, including sensitive PII. This practice exposes organizations to security risks and compliance issues due to the potential for data breaches. The disclosed concept addresses this problem by using database views to provide masked data without the need to duplicate sensitive information. The concept comprises a configuration process where columns containing PII are identified and registered in a PDiLL (Production Data in Lower Levels) configuration table.

Example systems provided herein can include one or more processors and non-transitory computer-readable storage media, that encode instructions which, when executed, perform operations such as identifying relevant PII columns, registering these columns in a PDiLL configuration table, and generating database view definitions. These definitions instruct the system to replace PII data within the identified columns with null values or other forms of anonymized data, thus creating compliant views.

Once the compliant views are generated, they can be deployed within the governed, secured, and segregated lane of environment, without exposing PII data, ensuring that any data accessed through these views remains confidential and secure, mitigating risks associated with data breaches. Furthermore, the concept allows for dynamic updating of the database views in response to changes in data structure or privacy requirements specified in the configuration table.

To facilitate testing and development in non-production environments, the concept extracts data from the compliant production views and loads it into user acceptance testing (UAT) objects. This ensures that the test data mirrors the structure and complexity of production data but without any sensitive PII, thereby supporting effective testing processes while adhering to stringent data protection standards.

The disclosed embodiments provide a technological solution to specific problems in the field of data management and security, namely the risks and inefficiencies associated with traditional methods of handling sensitive data in non-production environments. By employing database views that dynamically present modified data without physical duplication, the concept facilitates the secure masking of personally identifiable information (PII), ensuring compliance with stringent data protection standards.

Moreover, the concept enhances processing speeds by eliminating the need for extensive data storage typically required for duplicating and masking sensitive data across multiple testing environments. Specifically, by substituting traditional data storage with dynamic database views that display only masked data, the concept reduces the volume of data stored and processed. This reduction not only alleviates the burden on storage infrastructure but also accelerates data access and manipulation. Consequently, this leads to quicker turnaround times for testing and development cycles, enhancing overall system performance and providing a robust solution that is both efficient and effective in managing sensitive data in compliance with regulatory requirements.

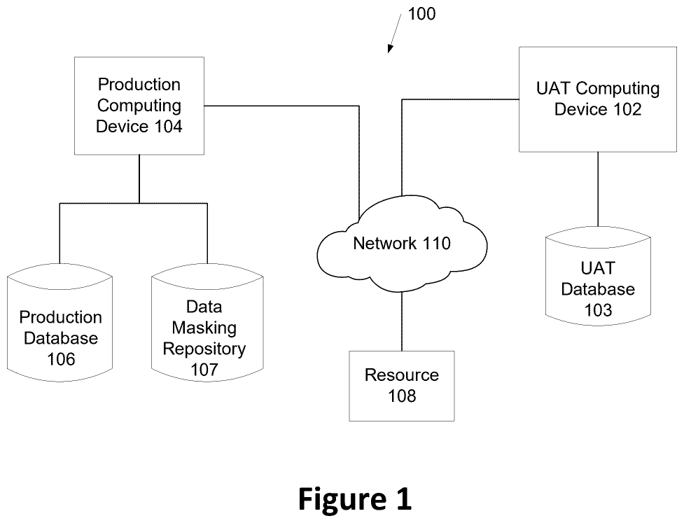

FIG. 1 illustrates an example computer system 100 configured for masking PII in non-production environments. As depicted in FIG. 1, the computer system 100 encompasses a computing environment comprised of one or more UAT computing devices 102 connected to a production computing device 104 via a network 110. Each of these devices may be implemented as one or more computing devices, each equipped with at least one processor and memory. Example computing devices include mobile computers, desktop computers, server computers, or other computing devices or devices such as server farms or cloud computing environments used to generate or manage masked data.

The UAT computing device 102 can be computing devices equipped with processors and memory, capable of initiating various tasks related to testing the application interfaces and functions using the masked data. In embodiments, the UAT computing device 102 can be in communication with a UAT database 103, which can serve as a repository designed for user acceptance testing. For example, in some embodiments, the UAT database 103 can store test data that mirrors the structure and complexity of production data but with sensitive PII masked or anonymized, as well as to support various operations, such as data extraction, loading, and validation, to facilitate thorough and secure testing of software applications.

The production computing device 104, which may be a single server or a collection of servers within a server farm, possesses computing resources including processors and data storage repositories, enabling the one or more UAT computing devices 102 to acquire user data to engage in effective testing of software applications. The analytical capabilities of the production computing device 104 can be directed at processing and managing the database views that mask PII, ensuring data security and integrity across systems.

In some embodiments, the production computing device 104 can be in communication with a production database 106 and a data masking repository 107. The production database 106 can be configured to store data from the production environment, which may include a variety of PII such as names, social security numbers, addresses, contact information, and financial details. The production database 106 can serve as the primary storage facility for all production data before any masking or anonymization processes are applied. The data masking repository 107 can maintain configurations and rules for data masking, ensuring consistent application of data masking techniques across the system to protect sensitive information while enabling comprehensive testing and compliance with privacy regulations.

Although depicted as physically distinct devices, the UAT computing devices 102 and the production computing device 104 can share resources such as processors and databases, enabling a unified approach to managing and testing the masked data. In certain embodiments, the production computing device 104 may also incorporate resources from a third-party vendor or contracting partner, depicted as resource 108. These resources 108 can include one or more generative pre-trained transformers or other algorithms or features to enhance the functionality and efficiency of the data masking processes described herein.

The network 110 serves as the underlying communication framework, facilitating data exchange and interaction between the UAT computing devices 102 and the production computing device 104. Additionally, the network 110 enables the reliable and secure transmission of data and commands within computer system 100, supporting real-time analysis and testing based on the masked data processed by the production computing device 104 and reviewed on the UAT devices.

The computer system 100 may be owned by a financial institution, and the production computing device 104 can be configured to communicate with other devices for broader data management tasks. For example, the UAT computing device 102 can be programmed to communicate with the production computing device 104 to perform various tasks, such as simulating financial transactions using the masked data. Many other configurations are possible, and the disclosure is not limited to the financial industry, but extends to any field requiring secure data handling in non-production environments.

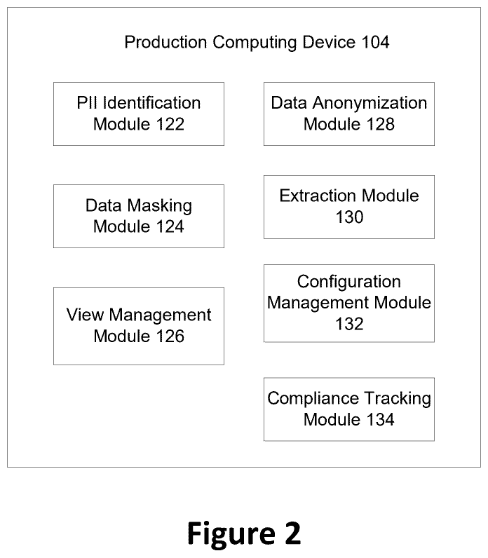

As shown in FIG. 2, the production computing device 104 can comprise one or more modules, with each module configured as a specialized component adapted to perform specific computational processing tasks within the computer system 100. In certain embodiments, the production computing device 104 can incorporate the following modules: PII identification module 122, data masking module 124, view management module 126, data anonymization module 128, extraction module 130, configuration management module 132, and compliance tracking module 134. Together, these modules constitute a comprehensive sub-system within the production computing device 104, facilitating the effective identification, masking, and management PII across various databases and applications. The sub-system can aid in ensuring that all data handling processes comply with legal and regulatory standards for data privacy and security, while also providing dynamic, scalable solutions for maintaining data integrity and accessibility in non-production environments.

The PII identification module 122 can be configured to scan database tables for columns that contain PII. In embodiments, the PII identification module 122 can be tuned to detect PII based on predefined criteria or metadata associated with each database column. Such criteria may include data labels or tags denoting sensitivity, such as ‘name’, ‘social security number’, ‘address’, ‘phone number’, ‘email address’, and the like. These tags can be indicative of PII and maybe present in databases accumulating user information during transactions or interactions with services, such as online banking platforms.

In the context of an online banking feature, user inputs collected may include details necessary for transaction processing or account management, which could encompass account numbers, transaction histories, contact information, and login credentials. While these inputs are invaluable for creating robust test environments that mirror real-world operations—thereby enhancing software development and quality assurance processes—they can also comprise sensitive information that must be protected to prevent unauthorized access and ensure regulatory compliance.

To enhance its capability to accurately identify PII, the PII identification module 122 can incorporate advanced pattern recognition and machine learning algorithms, for example with the assistance of resource 108. These technologies can enable the PII identification module 122 to go beyond static or predefined detection parameters by enabling dynamic recognition of new or ambiguous PII entries that might not be explicitly tagged or previously categorized as sensitive. For example, the PII identification module 122 can learn to identify patterns that suggest PII in free-text fields or non-standard data entries, such as unique identifiers embedded within transaction descriptions in online banking data. In some embodiments, this can include detecting sequences of digits or combinations of letters and numbers that conform to typical formats of confidential data, such as credit card numbers or national identification numbers.

In scenarios where a user interacts with an online banking feature to set up security questions, the entered data might not always be clearly classified as PII. However, these responses can contain sensitive personal information. The PII identification module 122, through its pattern recognition capabilities, can identify these as PII by recognizing contextually relevant patterns or by learning from past instances where similar entries were handled as sensitive data. This functionality ensures that all potential PII, regardless of its initial categorization or obscurity, is accurately identified and processed with the highest security protocols, thus maintaining the integrity and confidentiality of the test environments and the data they utilize.

Through these mechanisms, the data masking module 124 ensures that all access to sensitive data via the created views adheres strictly to the privacy standards set forth by the organization and regulatory bodies, thereby upholding the integrity and confidentiality of the data managed within the system.

The data masking module 124 is configured to facilitate the secure handling of PII within non-production environments. The data masking module 124 operates by registering identified columns containing PII into a dedicated configuration table, alternatively referred to as a PDiLL configuration table. In embodiments, the configuration table can be represented by a listing of columns including metadata about each column, such as data type, sensitivity level, and specific masking rules applicable to that data.

In embodiments, data type can refer to the kind of data stored in a column, such as integer, string, date, or complex data types like JSON or XML. Understanding the data type can be important for determining the appropriate masking techniques that can be applied without causing data corruption or loss of essential format and functionality.

Metadata regarding a sensitivity level can be used to categorize the degree of sensitivity associated with the data in a column. For example, data could be classified into levels such as “Public,” “Internal,” “Confidential,” and “Highly Confidential.” The sensitivity level can help dictate the rigor of masking needed to ensure adequate security measures are maintained.

The masking rule can define the specific method of anonymization or pseudonymization to be applied to the data. Masking rules may vary widely, from simple nullification of data to more complex transformations such as generating realistic but non-real anonymized data, or using tokenization to replace sensitive data with a non-sensitive placeholder but maintaining a reference to the original data for necessary operations.

The data masking module 124, after registering the necessary columns and their respective metadata in the configuration table, can proceed to generate one or more database view definitions. The database view definitions can be designed based on the masking rules specified in the configuration table, and can include explicit instructions to replace PII within the columns with appropriate forms of masked data. In embodiments, replacement strategies can involve setting the data to null values or replacing the data with anonymized data crafted to preserve the usability of the data while removing its ability to identify specific individuals.

For example, suppose a column named “Customer_SSN” in a database contains social security numbers. This column would be registered in the configuration table with a data type of “string,” a sensitivity level of “Highly Confidential,” and a masking rule that specifies replacement with null values. When the data masking module 124 processes this information, it could generate a database view definition where any query accessing the “Customer_SSN” column would not retrieve the actual social security numbers but would instead receive NULL in their place, effectively preventing exposure of sensitive information during testing or other non-production uses.

The view management module 126 is configured to manage the lifecycle and functionality of database views that present masked data within the governed, secured and segregated lane of production environments in accordance with the security policies and compliance requirements dictated by the data masking module 124 and the configuration parameters stored in the configuration table.

Upon receiving instructions from the data masking module 124, the view management module 126 can dynamically generate and update database views that incorporate the masking rules applied to the identified PII. These views ensure that any access to the data through standard query operations returns only the masked versions of the data, thereby inhibiting any inadvertent disclosure of sensitive information.

For example, consider a scenario where the PII identification module 122 detects a column named “Employee_Email” in a human resources database that contains employee email addresses, which are classified as PII. The data masking module 124, following its configured rules, registers this column with a masking rule to anonymize the data, perhaps by replacing the local part of the email (before the @ symbol) with a generic identifier such as “anonymous”.

The view management module 126 then acts upon these configurations to generate a database view. When this view is queried, instead of returning actual email addresses such as “john.doe@company.com”, it would return masked values like “anonymous@company.com”. This masking ensures that the structure of the data is preserved for functional and testing purposes while the identifiable portion is obscured, thus maintaining the utility of the data for operational tests without compromising the privacy and security of the underlying PII.

Furthermore, the view management module 126 can monitor and react to changes in the configuration table or the underlying data structure. If a new column is added or an existing column is reclassified as containing PII, the module updates the views accordingly to include masking for these columns, ensuring continuous protection of sensitive data. The view management module 126 can also provide tools for administrators to manually adjust view definitions if custom situations arise, such as temporary access needs for auditing or troubleshooting that require different view configurations.

The data anonymization module 128 is configured to enhance the privacy and security of PII by applying advanced anonymization techniques. The data anonymization module 128 can be configured to generate compliant views that transform sensitive data into a format that mitigates the risk of re-identification while maintaining the utility of the data for testing and analysis in non-production environments.

One of the techniques employed by the data anonymization module 128 is tokenization, where sensitive data elements are substituted with non-sensitive equivalents, known as tokens. These tokens can be used within the data system without exposing the underlying sensitive information. For example, a customer's credit card number might be replaced with a token that retains the format of a card number but does not carry any actual financial information. This technique is particularly useful in environments where data integrity is crucial for operational processes.

Another technique is data scrambling, which involves rearranging or altering the actual data values to obscure the original information. This method can be reversible or irreversible, depending on the security requirements and the intended use of the data. An example of data scrambling could involve shifting dates in a dataset by a random number of days, making the exact timing of events indiscernible while preserving the sequence and duration of the events.

Additionally, the data anonymization module 128 is capable of synthetic data generation, where entirely new datasets are created that statistically mirror the original data but do not contain any real PII. This involves generating data based on patterns and relationships found in the original data, allowing for the preservation of data utility for analytical and testing purposes without any risk of exposing actual sensitive information. For instance, a synthetic dataset for a marketing analysis might be generated that mimics shopper behavior and purchasing patterns without using any real shopper identities or transaction details.

By integrating these techniques, the data anonymization module 128 can effectively anonymize PII, thereby supporting compliance with data protection laws and maintaining the confidentiality and integrity of sensitive information. Through tokenization, data scrambling, and synthetic data generation, the module ensures that all data handled within the system is protected, allowing for secure and effective testing and development in non-production settings.

The extraction module 130 is configured to facilitate the extraction of test data from the one or more compliant views generated by the data anonymization module 128 for use in user acceptance testing (UAT) scenarios. Specifically, the extraction module 130 can be configured to load the extracted test data into a user acceptance testing object, which can form a part of a larger integrated development environment, for example, used in software development and testing.

In certain embodiments, the extraction module 130 can be enhanced with capabilities to apply additional filters or transformations to the test data extracted from the compliant views. This functionality can further aid in ensuring that no PII is inadvertently included in the datasets used during testing phases. For instance, even after initial data masking, the extraction module may apply further anonymization techniques such as additional scrambling or synthetic data adjustments to further disguise any residual data patterns that might lead to identification.

Furthermore, the user acceptance testing object, managed by the extraction module 130 can be integrated into development workflows within the integrated development environment, to facilitate continuous testing and validation processes, ensuring that all development stages are supported by data that closely mirrors production environments yet remains fully compliant with privacy standards.

In some configurations, the extraction module 130 is located external to the production computing device 104, such as within the UAT computing device 102. This placement allows for direct management of the data extraction processes at the point of testing, enhancing responsiveness and reducing latency in data handling. Additionally, the extraction module 130 can be configured to periodically refresh the test data from the one or more compliant views, to ensure that the data used in UAT remains up-to-date and relevant to ongoing development needs, thereby supporting dynamic development environments with continuously evolving data requirements.

The configuration management module 132 can be configured to manage and update the configuration table. The configuration management module 132 can be tasked with ensuring the accuracy and efficacy of data masking strategies through diligent management of the table, which includes key settings such as masking rules, PII definitions, and other pertinent configuration details.

In some embodiments, the configuration management module 132 can facilitate the dynamic adaptation of the data masking strategy in response to new compliance requirements or changes in the data structure. By continuously monitoring regulatory changes and data environment alterations, the configuration management module 132 can update the configuration table to reflect these changes, thereby ensuring that the data masking processes remain compliant and effective.

For example, suppose new data protection regulations are enacted, requiring enhanced anonymization techniques for certain types of PII that were previously masked using less stringent methods. In response, the configuration management module 132 can update the masking rules in the configuration table to implement more rigorous anonymization techniques, such as synthetic data generation for those specific types of PII.

Additionally, if a new data type is added to the database that contains PII, such as biometric information, the configuration management module 132 can classify this new data type under an appropriate sensitivity level in the configuration table and apply suitable masking rules. For instance, it might set biometric data as “Highly Confidential” and require that it be masked with advanced tokenization methods to ensure that no actual biometric data is exposed during testing or other non-production activities.

The compliance tracking module 134 is configured to perform functions concerning the oversight and documentation of all data masking activities related to the handling of PII. For example, in one embodiment, the compliance tracking module 134 is specifically tasked with ensuring that these activities adhere to applicable data protection regulations, thereby safeguarding the integrity of the data management processes within non-production environments.

Primarily, the compliance tracking module 134 can be configured to create and maintain a comprehensive audit log, which records detailed operations related to the masking of PII, documenting actions such as the identification of PII by the PII identification module 122, the application of masking rules by the data masking module 124, and the deployment of compliant views by the view management module 126. Each entry in the audit log can include timestamps, user identification, and descriptions of the actions taken, providing a transparent and traceable record that supports accountability and compliance verification.

Moreover, the compliance tracking module 134 can generate compliance reports based on the data accumulated in the audit logs. These reports can be structured to provide insights into the efficacy and conformity of the data masking practices with relevant legal and regulatory frameworks for internal audits, regulatory reviews, and compliance assessments, offering a structured evaluation of compliance statuses and highlighting any areas needing attention or improvement.

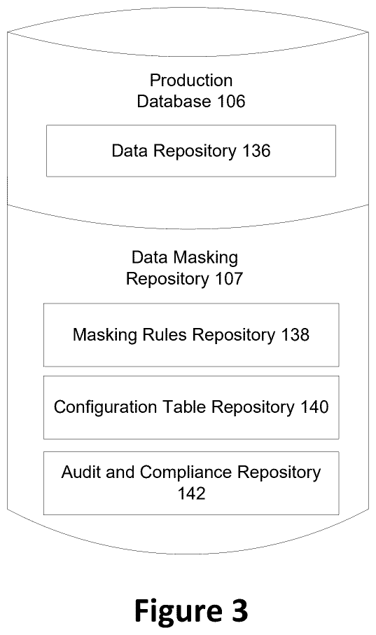

As shown in FIG. 3, in some embodiments, the production database 106 and the data masking repository 107 can be combined into a single storage service or sub-system, alternatively the production database 106 and the data masking repository 107 can comprise separate, independent devices. Each repository is configured to perform distinct functions within the database architecture. Specifically, production database 106 includes the data repository 136, and the data masking repository 107 includes a masking rules repository 138, a configuration table repository 140, and an audit and compliance repository 142. These repositories collectively enhance the database's capability to manage, secure, and audit data efficiently, especially in relation to handling PII in compliance with data protection regulations.

The data repository 136 can be configured to securely store and manage production data, including a wide range of personally identifiable information (PII) such as names, social security numbers, addresses, and financial details. It serves as the primary storage facility within the production environment, ensuring that all data is maintained with the highest levels of security and integrity. The data repository 136 supports the efficient retrieval and processing of data by the production computing device 104, facilitating operations like data masking and compliance tracking while adhering to organizational and regulatory data protection standards.

The masking rules repository 138 can be configured to store metadata concerning identified PII data fields. This metadata includes the location of the PII within the database, the sensitivity level of the data, and the current masking status. The masking rules repository 138 can act as a reference point for the PII Identification module 122, facilitating the accurate identification and subsequent handling of sensitive data according to predefined security protocols.

The configuration table repository 140 can be configured to house the configuration table, which contains the rules and other components necessary for the execution of data masking processes as generated by the data masking module 124. The configuration table repository 140 can ensure that the configurations and rules are centrally managed and accessible, supporting the consistent application of data masking techniques across the system.

The audit and compliance repository 142 can be configured to maintain comprehensive records of all data masking operations. These records can include details about who accessed the data, what modifications were made, and the timestamps of these activities. The audit and compliance repository 142 can aid in ensuring accountability and compliance with data protection regulations, providing a transparent audit trail that can be reviewed to verify the adherence to legal and organizational standards.

Together, these repositories form a robust infrastructure within production database 106, supporting the system's requirements for data integrity, security, and compliance in handling personally identifiable information within non-production environments.

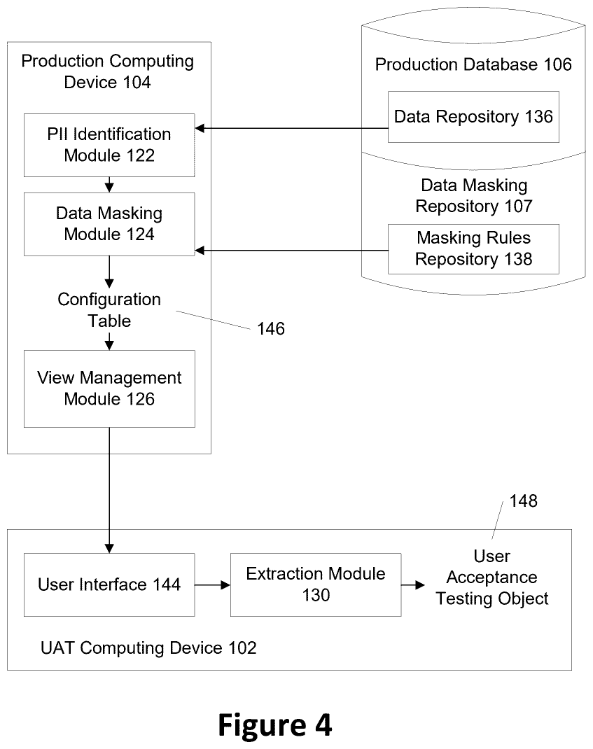

FIG. 4 illustrates an example embodiment of the UAT computing device 102, production computing device 104 and production database 106 of FIG. 1 implementing the generation of compliant views for data masking. In this embodiment, the extraction module 130 is remote from the production computing device 104 and production database 106.

In certain implementations, data can be pulled from the data repository 136. Requests for this data can be facilitated via the user interface 144, which may be located within the UAT computing device 102. This modular arrangement allows for the decentralized management of data extraction, aligning with distributed system architectures. Following data retrieval, the PII identification module 122 can examine the extracted data to detect any sensitive information, potentially employing detection algorithms to ensure comprehensive coverage of all potentially sensitive data elements.

Once sensitive information is identified, the data masking module 124, in collaboration with the masking rules repository 138, can establish a configuration table 146, outlining the specific masking rules that are to be applied in subsequent data handling stages. These rules can be designed to ensure the anonymization of sensitive data while maintaining the utility of the data for testing and development purposes.

Thereafter, the view management module 126 can be configured to generate one or more compliant views within the governed, secured, and segregated lane of production environment. These views can be configured to display the data in accordance with the established masking rules, ensuring that no sensitive information is exposed during the data handling process. In some embodiments, the generation of these views can be particularly tailored for display on a user interface 144, facilitating easy access and interaction with the masked data.

The extraction module 130 can be configured to extract test data from the compliant views for loading into a user acceptance testing object 148. Additionally, this enables validating the integrity and effectiveness of the data masking process, ensuring that the test data reflects the characteristics of the original data minus the sensitive elements, thereby enabling accurate and secure testing activities.

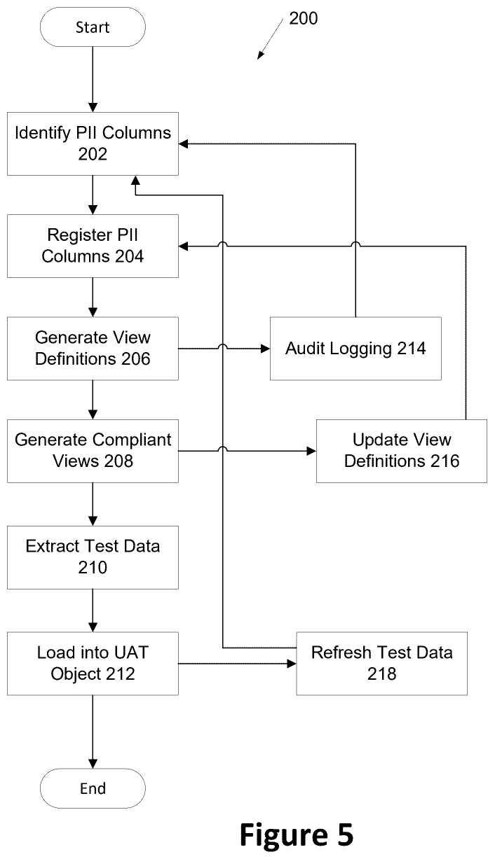

Referring to FIG. 5, an exemplary method 200 is illustrated for masking PII within a non-production environment, implemented by the computer system 100. This method 200 comprises a sequence of steps and can be implemented by the computer system 100. For instance, the production computing device 104 is configured to interact with the UAT computing device 102, production database 106, and the resource 108 via the network 110 to facilitate the execution of the steps outlined in method 200.

The method can be initiated with step 202, where the system identifies one or more columns within a database application that contain PII. This identification process can leverage machine learning techniques to automatically detect columns containing sensitive information. Following identification, step 204 involves registering these columns in a configuration table, where metadata about each column, including data type, sensitivity level, and a specific masking rule, is stored.

At step 206, the system can generate one or more database view definitions that instruct on replacing the PII data within the identified columns with null values or anonymized data. This may involve employing a data anonymization engine that utilizes tokenization, data scrambling, or synthetic data generation to ensure robust anonymization.

Step 208 sees the generation of one or more compliant views within the secured, governed and segregated lane of production environment, incorporating a validation process to verify the integrity and accuracy of the views before they are finalized. Once the views are established, step 210 can extract test data from these views, applying filters or transformations to ensure that no PII is inadvertently included in the subsequent outputs.

In step 212, the extracted and filtered test data can be loaded into a user acceptance testing object, which can be part of a larger integrated development environment used for software development and testing, ensuring that the development process utilizes data that closely mirrors real-world scenarios while adhering to data privacy standards.

Step 214 involves audit logging, which is related to the operations of generating view definitions and enhancing the identification of PII data. This logging can serve as an aid in compliance monitoring and creating an audit trail of all data masking activities. In step 216, the system can update the database view definitions in response to any changes in the database application's data structure or privacy requirements, ensuring that the masking rules remain effective and compliant.

Step 218 enables refreshing of the test data from the compliant views in the user acceptance testing object to maintain the relevance and accuracy of the test data. This refresh process ensures that the method operates as a continuous loop, adapting to new data inputs and regulatory changes to sustain data integrity and compliance over time.

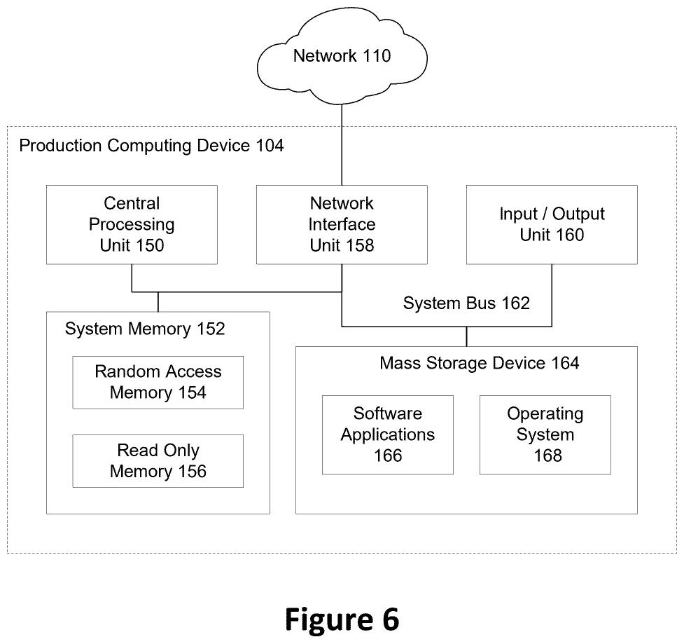

As illustrated in the embodiment of FIG. 6, the example production computing device 104, which provides the functionality described herein, can include at least one central processing unit (“CPU”) 150, a system memory 152, and a system bus 162 that couples the system memory 152 to the CPU 150. The system memory 152 includes a random-access memory (“RAM”) 154 and a read-only memory (“ROM”) 156. A basic input/output system containing the basic routines that help transfer information between elements within the production computing device 104, such as during startup, is stored in the ROM 156. The production computing device 104 further includes a mass storage device 164. The mass storage device 164 can store software instructions and data. A central processing unit, system memory, and mass storage device similar to that shown can also be included in the other computing devices disclosed herein.

The mass storage device 164 is connected to the CPU 150 through a mass storage controller (not shown) connected to the system bus 162. The mass storage device 164 and its associated computer-readable data storage media provide non-volatile, non-transitory storage for the production computing device 104. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the production computing device 104.

According to various embodiments of the invention, the production computing device 104 may operate in a networked environment using logical connections to remote network devices through network 110, such as a wireless network, the Internet, or another type of network. The production computing device 104 may connect to network 110 through a network interface unit 158 connected to the system bus 162. It should be appreciated that the network interface unit 158 may also be utilized to connect to other types of networks and remote computing systems. The production computing device 104 also includes an input/output controller 160 for receiving and processing input from a number of other devices, including a touch user interface display screen or another type of input device. Similarly, the input/output controller 160 may provide output to a touch user interface display screen or other output devices.

As mentioned briefly above, the mass storage device 164 and the RAM 154 of the production computing device 104 can store software instructions and data. The software instructions include an operating system 168 suitable for controlling the operation of the production computing device 104. The mass storage device 164 and/or the RAM 154 also store software instructions and applications 166, that when executed by the CPU 150, cause the production computing device 104 to provide the functionality of the production computing device 104 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for masking personally identifiable information data, the computer system comprising:
one or more processors; and
non-transitory computer-readable storage media encoding instructions which, when executed by the one or more processors, causes the computer system to:
identify one or more columns within a database application that contain the personally identifiable information data;
register the one or more columns in a configuration table;
generate one or more database view definitions, wherein the one or more database view definitions include instructions to replace the personally identifiable information data within the one or more columns with at least one of null values or anonymized data to create one or more compliant views;
generate the one or more compliant views; and
extract test data from the one or more compliant views for loading into a user acceptance testing object.

2. The computer system of claim 1, wherein identifying the one or more columns includes using machine learning techniques to automatically detect the one or more columns containing the personally identifiable information data.

3. The computer system of claim 1, wherein the configuration table includes metadata about each of the one or more columns, including a data type, a sensitivity level, and a masking rule.

4. The computer system of claim 1, wherein the one or more compliant views are generated by a data anonymization module that employs at least one of tokenization, data scrambling, or synthetic data generation.

5. The computer system of claim 1, further comprising instructions to validate an integrity and accuracy of the one or more compliant views before generation in a production environment.

6. The computer system of claim 1, wherein extracting data includes applying a filter or transformation to the test data extracted from the one or more compliant views to aid in ensuring that no personally identifiable information is inadvertently included in the user acceptance testing object.

7. The computer system of claim 1, further comprising instructions which, when executed, enable the computer system to create an audit log of operations related to masking of the personally identifiable information data.

8. The computer system of claim 1, further comprising instructions to update the one or more database view definitions in response to a change in a data structure of the database application or privacy requirements in the configuration table.

9. The computer system of claim 1, wherein the user acceptance testing object is part of a larger integrated development environment used for software development and testing, and the computer system includes instructions for integrating the user acceptance testing object directly into development workflows.

10. The computer system of claim 1, further comprising instructions for periodically refreshing the test data from the one or more compliant views in the user acceptance testing object.

11. A method for masking personally identifiable information data in a non-production environment, the method comprising:
identifying one or more columns within a database application that contain personally identifiable information data;
registering the one or more columns in a configuration table;
generating one or more database view definitions, wherein the one or more database view definitions include instructions to replace the personally identifiable information data within the one or more columns with at least one of null values or anonymized data to create one or more compliant views;
generating the one or more compliant views in a production environment; and
extracting test data from the one or more compliant views for loading into a user acceptance testing object.

12. The method of claim 11, wherein identifying the one or more columns includes using machine learning techniques to automatically detect the one or more columns containing the personally identifiable information data.

13. The method of claim 11, wherein registering the one or more columns in the configuration table includes storing metadata about each of the one or more columns, comprising data type, sensitivity level, and a masking rule.

14. The method of claim 11, wherein generating the one or more compliant views includes using a data anonymization engine that employs at least one of tokenization, data scrambling, or synthetic data generation.

15. The method of claim 11, further comprising validating an integrity and accuracy of the one or more compliant views before their generation in the non-production environment.

16. The method of claim 11, wherein extracting test data includes applying a filter or transformation to the test data extracted from the one or more compliant views to ensure that no PII is inadvertently included in the user acceptance testing object.

17. The method of claim 11, further comprising creating an audit log of operations related to the masking of the personally identifiable information data, performed by one or more processors.

18. The method of claim 11, further comprising updating the one or more database view definitions in response to a change in a data structure of the database application or privacy requirements indicated in the configuration table.

19. The method of claim 11, wherein integrating the user acceptance testing object into a larger integrated development environment used for software development and testing includes using the test data directly in development workflows.

20. The method of claim 11, further comprising periodically refreshing the test data from the one or more compliant views in the user acceptance testing object.
